(19) United States
(12) Patent Application Publication
(10) Pub. No.: US 2026/0269372 A1
(43) Pub. Date: Sep. 10, 2026

(54) THERMAL BARRIER ASSEMBLIES WITH SLOTTED THERMAL FINS

(71) Applicant: FORD GLOBAL TECHNOLOGIES, LLC, Dearborn, MI (US)

(72) Inventors: Mihir Devendra UPADHYE, Livonia, MI (US); Sangyeon KIM, Northville, MI (US)

(21) Appl. No.: 19/258,039

(22) Filed: Jul. 2, 2025

Related U.S. Application Data
(60) Provisional application No. 63/766,623, filed on Mar. 4, 2025.

(51) Int. Cl. H01M 10/658; H01M 10/613; H01M 10/6551; H01M 10/6557; H01M 10/6569; H01M 50/211; H01M 50/249; H01M 50/289

(52) U.S. Cl. CPC H01M 10/658; H01M 10/613; H01M 10/6551; H01M 10/6557; H01M 10/6569; H01M 50/211; H01M 50/249; H01M 50/289; H01M 2220/20

(57) ABSTRACT

Thermal barrier assembly designs are provided for use within traction battery packs. An exemplary traction battery pack may include a battery array having a cell stack housed within an array housing. The cell stack may include one or more thermal barrier assemblies arranged between adjacent battery cells of the cell stack. Each thermal barrier assembly may include a slotted thermal fin that allows for a thin layer of coolant to be present within the thermal barrier assembly. During a battery thermal event, the thin layer of coolant can vaporize, thereby leveraging the latent heat of vaporization for transferring thermal energy from the battery cells to the coolant rather than across a cell-to-cell conduction path of the cell stack.

### CROSS-REFERENCE TO RELATED APPLICATIONS

This disclosure claims the benefit of U.S. Provisional Application No. 63/766,623, which was filed on Mar. 4, 2025 and is incorporated herein by reference in its entirety.

### TECHNICAL FIELD

This disclosure relates generally to electrified vehicle traction battery packs, and more particularly to slotted thermal barrier assemblies for use within battery arrays of traction battery packs.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a first battery cell, a second battery cell, and a thermal barrier assembly arranged between the first battery cell and the second battery cell. The thermal barrier assembly includes a thermal fin, and a coolant is received in a slot of the thermal fin.

In a further non-limiting embodiment of the foregoing traction battery pack, the first battery cell, the second battery cell, and the thermal barrier assembly are housed inside a housing that includes a top cover and a bottom cover.

In a further non-limiting embodiment of either of the foregoing traction battery packs, an upper fin portion of the thermal fin is fixedly secured to the top cover by an adhesive.

In a further non-limiting embodiment of any of the foregoing traction battery packs, a lower fin portion of the thermal fin is fixedly secured to the bottom cover by an adhesive.

In a further non-limiting embodiment of any of the foregoing traction battery packs, the first battery cell is part of a first cell packet of a battery array of the traction battery pack, and the second battery cell is part of a second cell packet of the battery array. The thermal barrier assembly separates a first compartment where the first cell packet resides from a second compartment where the second cell packet resides.

In a further non-limiting embodiment of any of the foregoing traction battery packs, the first compartment and the second compartment establish separate coolant flow passages for receiving the coolant.

In a further non-limiting embodiment of any of the foregoing traction battery packs, the slot extends vertically across a majority of a first height of a mid-fin portion of the thermal fin.

In a further non-limiting embodiment of any of the foregoing traction battery packs, the slot includes a first height that is larger than a second height of each of the first battery cell and the second battery cell.

In a further non-limiting embodiment of any of the foregoing traction battery packs, the slot includes an upper slot portion that extends above the first battery cell and the second battery cell and a lower slot portion that extends below the first battery cell and the second battery cell.

In a further non-limiting embodiment of any of the foregoing traction battery packs, the thermal fin is sandwiched between a first foam or thermal resistance material layer and a second foam or thermal resistance material layer.

In a further non-limiting embodiment of any of the foregoing traction battery packs, the slot includes a first height that is larger than a second height of each of the first foam or thermal resistance material layer and the second foam or thermal resistance material layer.

In a further non-limiting embodiment of any of the foregoing traction battery packs, the thermal fin is C-shaped.

In a further non-limiting embodiment of any of the foregoing traction battery packs, the thermal fin is I-shaped.

In a further non-limiting embodiment of any of the foregoing traction battery packs, the coolant is a dielectric fluid of an immersion thermal management system of the traction battery pack.

In a further non-limiting embodiment of any of the foregoing traction battery packs, the dielectric fluid is configured to vaporize during a battery thermal event to create a thermos-siphon that pulls an additional amount of the coolant upwardly through the slot.

A method involving a traction battery pack that includes a first battery cell, a second battery cell, and a thermal barrier assembly arranged between the first battery cell and the second battery cell according to another exemplary aspect of the present disclosure includes, among other things, during a battery thermal event that occurs inside the traction battery pack, vaporizing a first portion of a coolant that is present within a slotted thermal fin of the thermal barrier assembly, and utilizing a latent heat of vaporization of the first portion of the coolant to pull a second portion of the coolant through the slotted thermal fin and thereby mitigate a transfer of thermal energy from the first battery cell to the second battery cell.

In a further non-limiting embodiment of the foregoing method, vaporizing the first portion of the coolant creates a thermos-siphon that pulls the second portion of the coolant through the slotted thermal fin.

In a further non-limiting embodiment of either of the foregoing methods, the first portion of the coolant is present within a vertical slot of the slotted thermal fin prior to the battery thermal event.

In a further non-limiting embodiment of any of the foregoing methods, the first portion of the coolant enters the vertical slot through an upper slot portion or a lower slot portion of the vertical slot.

In a further non-limiting embodiment of any of the foregoing methods, the first portion of the coolant is present within a plurality of vertical slots of the slotted thermal fin prior to the battery thermal event.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle having a traction battery pack.

FIG. 2 illustrates an exemplary battery array of a traction battery pack.

FIG. 3 illustrates select portions of a cell stack of a battery array.

FIG. 4 is a cross-sectional view through section 4-4 of FIG. 3.

FIG. 5 is a cross-sectional view through section 5-5 of FIG. 3.

FIG. 6 illustrates an exemplary thermal barrier assembly.

FIG. 7 illustrates an exemplary thermal fin of a thermal barrier assembly.

FIG. 8 illustrates another exemplary thermal fin of a thermal barrier assembly.

### DETAILED DESCRIPTION

This disclosure details thermal barrier assembly designs for use within traction battery packs. An exemplary traction battery pack may include a battery array having a cell stack housed within an array housing. The cell stack may include one or more thermal barrier assemblies arranged between adjacent battery cells of the cell stack. Each thermal barrier assembly may include a slotted thermal fin that allows for a thin layer of coolant to be present in the thermal barrier assembly. During a battery thermal event, the layer of coolant can vaporize, thereby leveraging the latent heat of vaporization for transferring thermal energy from the battery cells to the coolant rather than across a cell-to-cell conduction path of the cell stack. These and other features are discussed in greater detail in the following paragraphs of this detailed description.

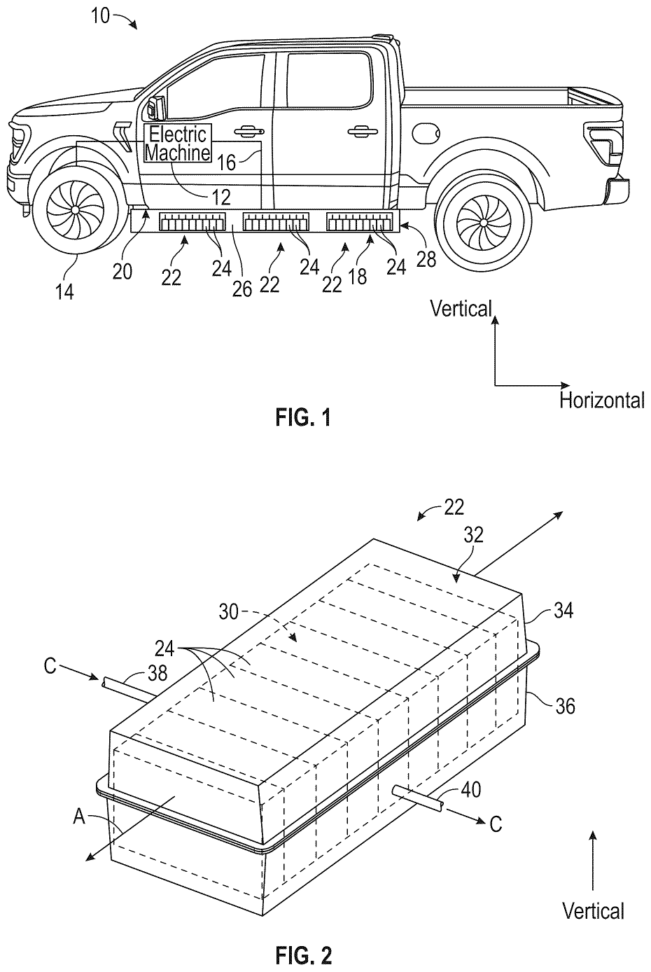

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery modules, assemblies, or groupings of rechargeable battery cells 24) capable of outputting electrical power to power the electric machine 12 and/or other electrical loads of the electrified vehicle 10. The one or more battery arrays 22 of the traction battery pack 18 may each include a plurality of battery cells 24 that store energy for powering the various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, lithium manganese rich, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28 of the traction battery pack 18. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

FIG. 2 illustrates features associated with a battery array 22 of a traction battery pack. For example, the traction battery pack 18 of the electrified vehicle 10 of FIG. 1 could include one or more battery arrays having a design substantially similar to that of the battery array 22 shown in FIG. 2.

The battery array 22 may include one or more cell stacks 30 housed inside an array housing 32. The array housing 32 may include a top cover 34 and a bottom cover 36, which may both be tray-like structures. The top cover 34 may be positioned vertically above the bottom cover 36. Various terms such as “above,” “below,” “top,” and “bottom” are used relative to the arrangement of the components of the traction battery pack 18 in the various drawings and should not otherwise be deemed limiting. These terms are referenced relative to the general orientation of the traction battery pack 18 when installed on the electrified vehicle 10 of FIG. 1. Vertical, for purposes of this disclosure, is also with reference to ground and the manner the traction battery pack 18 is oriented when installed on the electrified vehicle 10.

The top cover 34 may be secured (e.g., bolted, welded, adhered, etc.) to the bottom cover 36 to provide a sealed enclosure for housing the cell stack 30. The size, shape, and configuration of the array housing 32 could vary within the scope of this disclosure.

The cell stack 30 may include a plurality of the battery cells 24. Thermal energy levels of the battery cells 24 of the battery array 22 can increase as the electrified vehicle 10 is operated. A thermal management system can therefore be employed for managing the thermal energy levels of the battery cells 24 of the battery array 22. The thermal management system may be configured to route a coolant C through the interior of the array housing 32 of the battery array 22 in order to manage the thermal energy levels of the battery array 22 by, for example, using the coolant C to take on and carry away thermal energy from the battery cells 24 of the cell stack 30.

In an embodiment, the thermal management system is an immersion thermal management system in which portions of the cell stack 30, here at least portions of the battery cells 24, for example, can be immersed in the coolant C. Thermal energy can transfer between the coolant C and the battery cells 24 as the coolant C flows over and/or around the battery cells 24 inside the array housing 32. The coolant C can help manage thermal energy levels of the battery cells 24 as well as other components of the battery array 22.

The thermal management system can deliver the coolant C to the interior of the battery array 22 through an inlet 38 of the array housing 32. The coolant C can fill one or more open areas (see, e.g., compartments 42, which are best shown in FIGS. 4-5) inside the battery array 22 such that the battery cells 24 are directly contacted by the coolant C. The coolant C can take on thermal energy from the battery cells 24 for managing the thermal energy levels of the battery array 22. The coolant C may exit the battery array 22 through an outlet 40 of the array housing 32. In an embodiment, both the inlet 38 and the outlet 40 are provided through the bottom cover 36 of the array housing 32. However, other inlet 38 and/or outlet 40 locations are contemplated within the scope of this disclosure.

The coolant C exiting through the outlet 40 can move to a thermal energy exchange device (not shown), such as a heat exchanger, for example, where thermal energy can be transferred from the coolant C to atmosphere. A pump (not shown) can be operated to selectively circulate the coolant C between the battery array 22 and the thermal energy exchange device and then back to the battery array 22 as part of a closed-loop system.

The coolant C circulated in the immersion thermal management system may be a dielectric fluid or another type of non-electrically conductive fluid (e.g., oil) that is designed for immersion cooling the battery cells 24. However, other non-conductive fluids may also be suitable, and the actual chemical make-up and design characteristics (e.g., dielectric constant, maximum breakdown strength, boiling point, thermal conductivity, etc.) may vary depending on the environment the battery array 22 is to be deployed, among various other factors.

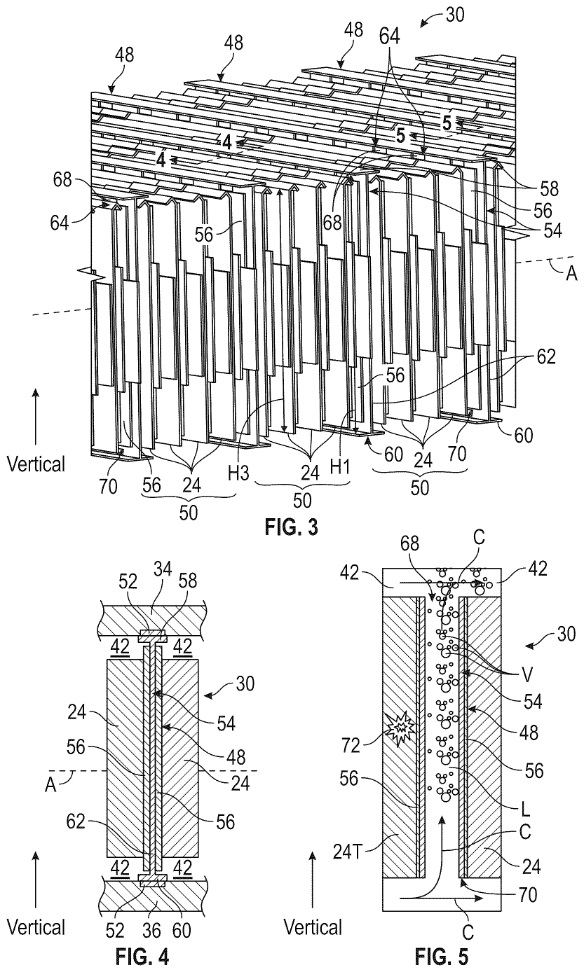

FIGS. 3-8 illustrate various details associated with the cell stack 30 of the battery array 22 of FIG. 2, its subcomponents, and its relationship to the array housing 32. The battery cells 24 of the cell stack 30 may be arranged together along a cell stack axis A. Although a single cell stack 30 having a specific number of battery cells 24 is illustrated in the figures of this disclosure, the battery array 22 could include any number of cell stacks 30, with each cell stack 30 having any number of individual battery cells 24.

A plurality of thermal barrier assemblies 48 can be interspersed along the cell stack axis A between adjacent battery cells 24 of the cell stack 30. The thermal barrier assemblies 48 may be configured to interface with the array housing 32 for compartmentalizing the battery array 22 into multiple compartments 42. Each compartment 42 may establish a dedicated coolant flow passage for directing the coolant C through the battery array 22 as part of the immersion thermal management system described above.

Each compartment 42 may house a cell packet 50, which is a subgrouping of the plurality of battery cells 24 of the cell stack 30. Each cell packet 50 may be disposed between adjacent pairs of the thermal barrier assemblies 48 of the cell stack 30. In an embodiment, each cell packet 50 includes four battery cells 24. However, other configurations are contemplated within the scope of this disclosure, and it should be evident to persons of ordinary skill in the art having the benefit of this disclosure that the cell stack 30 could include any amount and arrangement of battery cells 24, thermal barrier assemblies 48, cell packets 50, etc.

The thermal barrier assemblies 48 may include various designs/configurations within the scope of this disclosure. In an embodiment, each thermal barrier assembly 48 may include a thermal fin 54, which may be made of a metallic material such as aluminum, for example, that is flanked by additional layers 56 (best seen in FIGS. 3-6), such as foam and/or thermal resistance material layers, for example, as part of a multi-layered sandwich structure. The thermal barrier assemblies 48 may therefore include metallic materials, high temperature resistance thermoplastic or thermoset composites, aerogel materials, mica materials, foam materials, or any combination of these and/or other materials.

In an embodiment, the thermal fin 54 of each thermal barrier assembly 48 includes a I-shaped design (see FIG. 7) or an C-shaped design (see FIG. 8). However, other cross-sectional shapes are contemplated within the scope of this disclosure.

Each thermal fin 54 may include an upper fin portion 58, a lower fin portion 60, and a mid-fin portion 62 extending between the upper fin portion 58 and the lower fin portion 60. The upper fin portion 58 and the lower fin portion 60 may each be configured as a flange that extends at a transverse angle (e.g., about perpendicular) from the mid-fin portion 62. The upper fin portion 58 may be configured to interface with the top cover 34 of the array housing 32, and the lower fin portion 60 may be configured to interface with the bottom cover 36 of the array housing 32 (see, e.g., FIG. 4). The mid-fin portion 62 of each thermal fin 54 may be positioned axially between battery cells 24 of adjacent cell packets 50 of the cell stack 30.

The upper fin portions 58 of the thermal fins 54 may extend above the battery cells 24, and the lower fin portions 60 of the thermal fins 54 may extend below the battery cells 24. The thermal fins 54 can therefore aid in establishing the compartments 42. Should, for example, a battery thermal event occur in one of the compartments 42, the thermal barrier assemblies 48 can reduce or even prevent thermal energy associated with the thermal event from moving from cell-to-cell, compartment-to-compartment, and/or cell stack-to-cell stack, thereby inhibiting the transfer of thermal energy inside the battery array 22. Moreover, due to the increased contact with the array housing 32 achieved by the upper fin portions 58 and the lower fin portions 60, the thermal barrier assemblies 48 can provide increased thermal transfer mitigation performance by directing a greater amount of heat transfer into the array housing 32.

An adhesive 52 (see FIG. 4) may be utilized to secure the upper fin portion(s) 58 to the top cover 34 of the array housing 32 and the lower fin portions(s) 60 to the bottom cover 36 of the array housing 32, thereby structurally integrating the battery array 22 in a manner that increases its rigidity/stiffness. The adhesive 52 may be a structural adhesive, such as an epoxy based adhesive or a urethane based adhesive, for example. However, other types of adhesives are contemplated within the scope of this disclosure.

One or more slots 64 may be formed through the mid-fin portion 62 of each thermal fin 54. In an embodiment, the slots 64 are rectangular shaped. However, the size and shape of each slot 64 is not intended to limit this disclosure.

Each slot 64 may be a through-opening that is formed (e.g., stamped) through the mid-fin portion 62. Adjacent slots 64 may be separated from one another by a solid section 66 of the mid-fin portion 62.

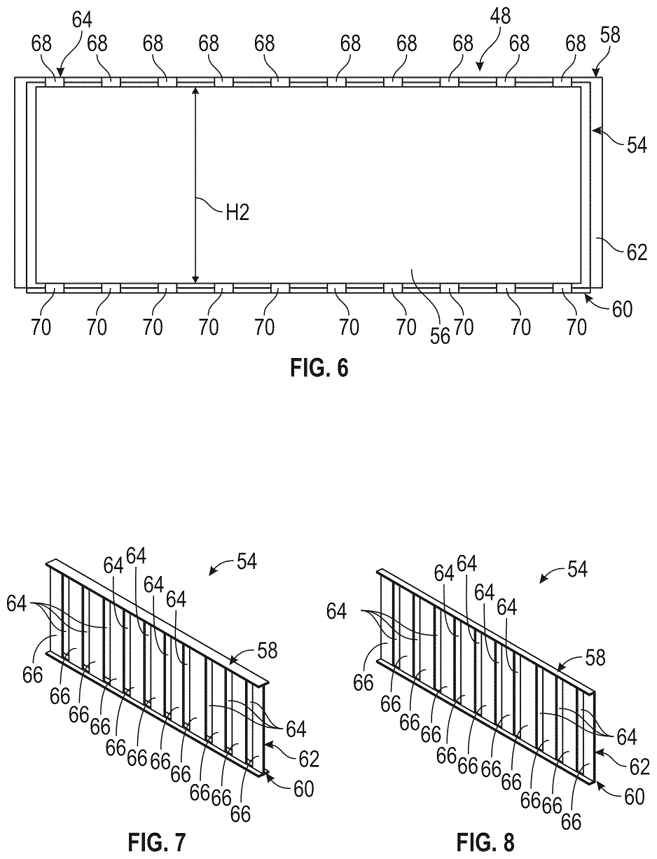

The slots 64 may extend vertically across a substantial portion of the height of the mid-fin portion 62. The slots 64 may include a first height H1 that is larger than both a second height H2 (see FIG. 6) of the layers 56 and a third height H3 of the battery cells 24. In a mounted position of the thermal barrier assembly 48 within the cell stack 30, each slot 64 may therefore extend both vertically above and vertically below the battery cells 24 of the cell stack 30.

An upper slot portion 68 of the slot 64 may extend vertically above the battery cells 24 to fluidly connect the slot 64 to one or more of the compartments 42 located above the cell stack 30, and a lower slot portion 70 of the slot 64 may extend vertically below the battery cells 24 to fluidly connect the slot 64 to one or more of the compartments 42 located below the cell stack 30 (best shown in FIG. 3). By virtue of being fluidly connected to the compartments 42 where the coolant C is circulated, the slots 64 can allow for a layer L (see FIG. 5) of the coolant C to be present within each thermal barrier assembly 48 for mitigating the transfer of thermal energy from cell packet-to-cell packet.

As schematically shown in FIG. 5, pressure and energy increases inside one or more battery cells 24 of the cell stack 30 can lead to a battery thermal event in which a triggering battery cell 24T discharges a flow of battery vent byproducts, which can include both gas and debris. The battery vent byproducts can be discharged from the triggering battery cell 24T through a designated cell vent or through a ruptured area of the triggering battery cell 24T. The triggering battery cell 24T can release a relatively large amount of thermal energy 72 during such a battery thermal event.

Once the battery thermal event has begun, the thermal energy 72 can conduct into the thermal barrier assembly 48 nearest to the triggering battery cell 24T. When a temperature of the thermal energy 72 exceeds a boiling point of the coolant C (e.g., around 200 degrees Celsius), the layer L of coolant C contained within each slot 64 of the thermal fin 54 of the thermal barrier assembly 48 can begin to locally boil, thus causing the coolant C to transition from a single-phase coolant to a two-phase fluid. A vapor phase V of the coolant C can then rise upwardly toward the compartments 42 located vertically above the cell stack 30, thereby creating a thermos-siphon phenomena that pulls fresh liquid-phase coolant C from the compartments 42 located vertically below the cell stack 30. In an embodiment, the fresh liquid-phase coolant C that is pulled into the slots 64 is pulled in a direction that is transverse (e.g., perpendicular) to a flow direction of the coolant C through the compartments 42. By leveraging the latent heat of vaporization of the vaporized coolant C in this manner, the thermal energy 72 associated with the triggering battery cell 24T can be efficiently transferred to the coolant C at the thermal barrier assembly 48 rather than to the battery cells 24 located on the other side of the thermal barrier assembly 48 from the triggering battery cell 24T. The thermal barrier assemblies 48 described herein can therefore substantially prevent the battery thermal event from cascading across the cell stack 30.

The exemplary thermal barrier assemblies of this disclosure include slotted thermal fins that allow for a thin layer of coolant to be present in the thermal barrier assembly. The vertical slots of the thermal fin allow for efficient transport of vapor phase coolant at the thermal barrier during a battery thermal even, thus facilitating heat transfer into the coolant rather than axially across the barrier to the battery cells of adjacent cell packets.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. A battery pack, comprising:
a first battery cell;
a second battery cell;
a thermal barrier assembly arranged between the first battery cell and the second battery cell, the thermal barrier assembly including a thermal fin; and
a coolant received in a slot of the thermal fin.

2. The battery pack as recited in claim 1, wherein the first battery cell, the second battery cell, and the thermal barrier assembly are housed inside a housing that includes a top cover and a bottom cover.

3. The battery pack as recited in claim 2, wherein an upper fin portion of the thermal fin is fixedly secured to the top cover by an adhesive.

4. The battery pack as recited in claim 2, wherein a lower fin portion of the thermal fin is fixedly secured to the bottom cover by an adhesive.

5. The battery pack as recited in claim 1, wherein the first battery cell is part of a first cell packet of a battery array of the battery pack, and the second battery cell is part of a second cell packet of the battery array, and further wherein the thermal barrier assembly separates a first compartment where the first cell packet resides from a second compartment where the second cell packet resides.

6. The battery pack as recited in claim 5, wherein the first compartment and the second compartment establish separate coolant flow passages for receiving the coolant.

7. The battery pack as recited in claim 1, wherein the slot extends vertically across a majority of a first height of a mid-fin portion of the thermal fin.

8. The battery pack as recited in claim 1, wherein the slot includes a first height that is larger than a second height of each of the first battery cell and the second battery cell.

9. The battery pack as recited in claim 1, wherein the slot includes an upper slot portion that extends above the first battery cell and the second battery cell and a lower slot portion that extends below the first battery cell and the second battery cell.

10. The battery pack as recited in claim 1, wherein the thermal fin is sandwiched between a first foam or thermal resistance material layer and a second foam or thermal resistance material layer.

11. The battery pack as recited in claim 10, wherein the slot includes a first height that is larger than a second height of each of the first foam or thermal resistance material layer and the second foam or thermal resistance material layer.

12. The battery pack as recited in claim 1, wherein the thermal fin is C-shaped.

13. The battery pack as recited in claim 1, wherein the thermal fin is I-shaped.

14. The battery pack as recited in claim 1, wherein the coolant is a dielectric fluid of an immersion thermal management system of the battery pack.

15. The battery pack as recited in claim 14, wherein the dielectric fluid is configured to vaporize during a battery thermal event to create a thermos-siphon that pulls an additional amount of the coolant upwardly through the slot.

16. A method involving a battery pack that includes a first battery cell, a second battery cell, and a thermal barrier assembly arranged between the first battery cell and the second battery cell, the method comprising:
during a battery thermal event that occurs inside the battery pack, vaporizing a first portion of a coolant that is present within a slotted thermal fin of the thermal barrier assembly; and
utilizing a latent heat of vaporization of the first portion of the coolant to pull a second portion of the coolant through the slotted thermal fin and thereby mitigate a transfer of thermal energy from the first battery cell to the second battery cell.

17. The method as recited in claim 16, wherein vaporizing the first portion of the coolant creates a thermos-siphon that pulls the second portion of the coolant through the slotted thermal fin.

18. The method as recited in claim 16, wherein the first portion of the coolant is present within a vertical slot of the slotted thermal fin prior to the battery thermal event.

19. The method as recited in claim 18, wherein the first portion of the coolant enters the vertical slot through an upper slot portion or a lower slot portion of the vertical slot.

20. The method as recited in claim 16, wherein the first portion of the coolant is present within a plurality of vertical slots of the slotted thermal fin prior to the battery thermal event.
